(19) United States
(12) Patent Application Publication
(10) Pub. No.: US 2014/0036533 A1
(43) Pub. Date: Feb. 6, 2014

(54) DUAL MODE LCD BACKLIGHT

(71) Applicant: Robert Smith-Gillespie, Eugene, OR (US)

(72) Inventor: Robert Smith-Gillespie, Eugene, OR (US)

(73) Assignee: E3 DISPLAYS, LLC, Phoenix, AZ (US)

(21) Appl. No.: 13/564,045

(22) Filed: Aug. 1, 2012

(51) Int. Cl. G02F 1/13357; F21V 7/04; F21V 17/00; G09F 13/04

(52) U.S. Cl. 362/609; 362/97.1; 362/97.2; 29/832

(57) ABSTRACT

LCD backlighting systems, and particularly LCD backlighting systems used in connection with night vision systems, may be configured to achieve reduced cost, reduced volume, and other desirable outcomes by use of a dual-mode configuration. In a dual-mode configuration, certain light sources are active in both day mode and night mode operation. Night mode light sources may be IR filtered in order to prevent disruption of operation of night vision equipment.

### TECHNICAL FIELD

The present disclosure relates to liquid crystal display backlighting, and in particular to backlighting suitable for use in night vision applications.

### BACKGROUND

Liquid crystal displays (LCDs) are passive display devices which electro-optically modulate light incident on the LCD panel. For this reason, LCDs require some form of illumination to present a viewable image. Most typically, the illumination source is placed behind the LCD as a backlight assembly comprising a light source(s) and optical elements to direct the light through the LCD.

Light sources used for LCD backlighting typically emit both visible light and some quantity of near infrared (IR) radiation. In displays used in certain military and civil applications where night vision imaging systems (NVIS) are used to enhance night-time sight of the wearers, the infrared radiation emitted by the display light sources is desirably filtered to prevent flooding the NVIS imager and thereby reducing its sensitivity and dynamic range. Accordingly, it remains desirable to provide improved. LCD backlighting systems, for example in order to reduce expense and/or increase efficiency, and particularly for use in connection with NVIS systems.

### SUMMARY

This disclosure relates to systems and methods for backlighting of liquid Crystal displays. In an exemplary embodiment, a mode-selectable backlighting system comprises a plurality of discrete light sources. The plurality of discrete light sources comprises a first group of discrete light sources and a second group of discrete light sources. The system further comprises a reflector having reflector cavities, each cavity corresponding to one of the plurality of discrete light sources, and a plurality of filters coupled to the reflector. One of the plurality of filters is disposed over each reflector cavity corresponding to one of the second group of discrete light sources.

In another exemplary embodiment, a single-edge LCD backlighting system comprises a printed circuit board having a plurality of discrete light sources mounted on a single side thereof. The plurality of light sources comprises a first set of light sources and a second set of light sources. The system further comprises a reflector having reflector cavities, each cavity corresponding to one of the plurality of discrete light sources, and a plurality of dichroic coated infrared cut-off filters coupled to the reflector. One of the plurality of filters is disposed over each reflector cavity corresponding to one of the second group of discrete light sources.

In another exemplary embodiment, a method of forming a dual-mode LCD backlighting system comprises providing a first set of discrete light sources and a second set of discrete light sources, the first set and the second set interleaved on a single side of a printed circuit board, coupling the printed circuit board to a reflector having reflector cavities, coupling an infrared filter to each reflector cavity corresponding to one of the second set of discrete light sources, and coupling the reflector to single side of a light guide plate.

### BRIEF DESCRIPTION OF THE DRAWINGS

With reference to the following description, appended claims, and accompanying drawings:

FIG. 1A illustrates an exemplary dual-mode LCD backlight system in accordance with an exemplary embodiment;

FIG. 1B illustrates a closer view of the exemplary dual-mode, backlight system of FIG, 1A;

FIG. 2A illustrates a sectional view of portions of an exemplary dual-mode LCD backlight system in accordance with an exemplary embodiment;

FIG. 2B illustrates certain portions (for example, light-emitting and/or filtering components) of an exemplary dual-mode LCD backlight system in accordance with an exemplary embodiment;

FIG. 3A illustrates a monolithic filter configured with patterned multi-layer coatings in accordance with an exemplary embodiment;

FIG. 3B illustrates filter characteristics of exemplary NVIS filter materials in accordance with an exemplary embodiment;

FIG. 3C illustrates relative spectral emission of an LCD under various backlighting configurations in accordance with an exemplary embodiment;

FIG. 3D illustrates relative spectral emission of an LCD under various backlighting configurations in accordance with an exemplary embodiment;

FIG. 4 illustrates an exemplary circuit for a dual-mode LCD backlight system in accordance with an exemplary embodiment; and

FIG. 5 illustrates a portion of an exemplary trace routing for the dual-mode LCD backlight system of FIG. 4 in accordance with an exemplary embodiment.

### DETAILED DESCRIPTION

The following description is of various exemplary embodiments only, and is not intended to limit the scope; applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims,

For the sake of brevity, conventional techniques and/or components for LCD backlighting, light emitting diode (LED) fabrication and/or configuration, electromagnetic filtering, and/or the like, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical LCD backlighting system, for example a dual-mode LED based LCD backlighting system.

Prior LCD backlighting systems, for example LCD backlighting systems employed in connection with NVIS systems, may suffer from various deficiencies. For example, many prior methods of filtering displays have been proposed that place near-IR filters (also called NVIS filters to clarify their unique performance requirements) over the entire LCD surface, or over the LCD backlight light, Such approaches can be cumbersome and/or expensive. Additionally, designs have been proposed which utilize multiple light sources, one set for day-mode (non-filtered), and another set for night-mode (NVIS filtered). Such approaches can suffer from reduced luminosity in day-mode operation due to the unutilized light sources in that mode.

Yet further, many prior LCD backlight systems have needed multiple light rails (for example, light rails disposed on opposing edges of a display) in order to achieve a desired luminosity. Such approaches are high in dollar cost due to the duplication of materials; moreover, such approaches increase the size of the resulting device due to the volume requirements of the multiple light rails.

Additionally, certain prior versions of dual-mode, direct-view NVIS backlights often utilize fluorescent lamp light sources as the primary or day-mode light sources. Secondary light sources, either fluorescent or LED lamps, are placed behind or to the side of the lighting cavity—thereby using the primary lamps and light cavity as a diffusing means for the NVIS light sources. In these approaches, the cavity depth is very large—for example, approximately 25-40 mm deep. Additionally, these designs have additional NVIS components that have little or no contribution to the day-mode lighting performance.

Moreover, certain prior versions of dual edge-lit NVIS backlights use two LED lamp rails with day-mode LEDs mounted on the front side of a printed circuit board, and the night-mode LEDs mounted on the rear side of the PCB through cutouts placed between the day-mode LED positions. These approaches suffer from various deficiencies. First, the through-mounting of LEDs weakens the PCB while increasing fabrication costs as well as assembly costs. Additionally, the thermal path from day-mode LEDs is through a thick printed circuit board, thereby increasing the operating temperature of the day-mode LEDs. Additionally, these approaches depend on dual edge illumination to ensure uniformity at the periphery of the display, especially in night-mode where the dark zones between filtered LEDs depend upon illumination from the opposing rail.

In contrast, highly luminous, efficient, inexpensive, and/or compact LCD backlighting systems, including dual-mode systems suitable for both daytime and NVIS usage, may be achieved by utilizing principles of the present disclosure. For example, by utilizing a single edge illumination scheme, a backlight greatly reduces system cost and complexity as well as minimizes size and weight of the completed display assembly. Moreover, by utilizing a combination of opaque, metalized reflector cavities with individual thin (for example, only about 0.5 mm thick) dichroic NVIS filters and optical expansion film on the light guide inlet, highly uniform lighting can be achieved with only single edge illumination.

Additionally, by utilizing highly efficient, dichroic coated IR cut-off filters (instead of colored glass filters) over a portion of the LEDs (for example, over ⅓ of the LEDs), it is possible to utilize the night-mode LEDs during day-triode operation. In various exemplary embodiments, for night-mode operation only the filtered LEDs are illuminated. However, because a dichroic filter provides very little color shift due to the steepness of the filter curve, it is possible to utilize the night-mode LEDs during day-mode operation. in an exemplary embodiment, an LCD backlighting system uses the same high-output LEDs for both day and night-mode light sources, thus allowing the combined use of the NVIS filtered LEDs with the unfiltered LEDs for day-mode operation. In this manner, systems configured in accordance with principles of the present disclosure can achieve higher luminance than achievable in designs using low-power secondary light sources.

Yet further, principles of the present disclosure contemplate placing all light sources (for example, LEDs) on a single plane of a single printed circuit board—allowing a thinner package with more thermally efficient operation than previous designs. In this manner, backlighting system can be created at a lower cost, for example by not requiring through-board mounting of the NVIS LEDs. Additionally, utilizing a single-layer flexible printed circuit board (FPC) allows for improved thermal dissipation, for example by directly attaching a FPC to an aluminum heat sink and then to an LCD panel chassis.

Moreover, by utilizing a compact, modular design, LCD backlighting systems configured in accordance with principles of the present disclosure are adaptable to commercial-off-the-shelf LCD modules without significant repackaging of the backlight components. For example, in various exemplary embodiments, LCD backlighting systems configured in accordance with principles of the present disclosure may be configured with a cavity depth of only about 5 mm for the entire backlight assembly.

Still further, LCD backlighting systems configured in accordance with principles of the present disclosure enable single rail designs, including designs that allow wide spacing (for example, 20 mm) between filtered LEDs with no noticeable reduction in illumination uniformity.

Exemplary LCD backlighting systems as disclosed herein may be configured as a dual-mode, NVIS backlight utilizing single edge, LED illumination, wherein the night-mode LEDs and day-mode LEDs are formed as a single linear array on a single, thin printed circuit assembly. in various exemplary embodiments, the night-mode LEDs are isolated via an opaque and highly reflective reflector assembly which houses a plurality of IR filters, one for each night-mode LED. Further, since the night-mode LEDs may be broadly spaced one from another, a means of optically spreading the light from the LEDs may be included on the inlet to the light guide to ensure uniform illumination of the LCD at a short distance from the LED light source.

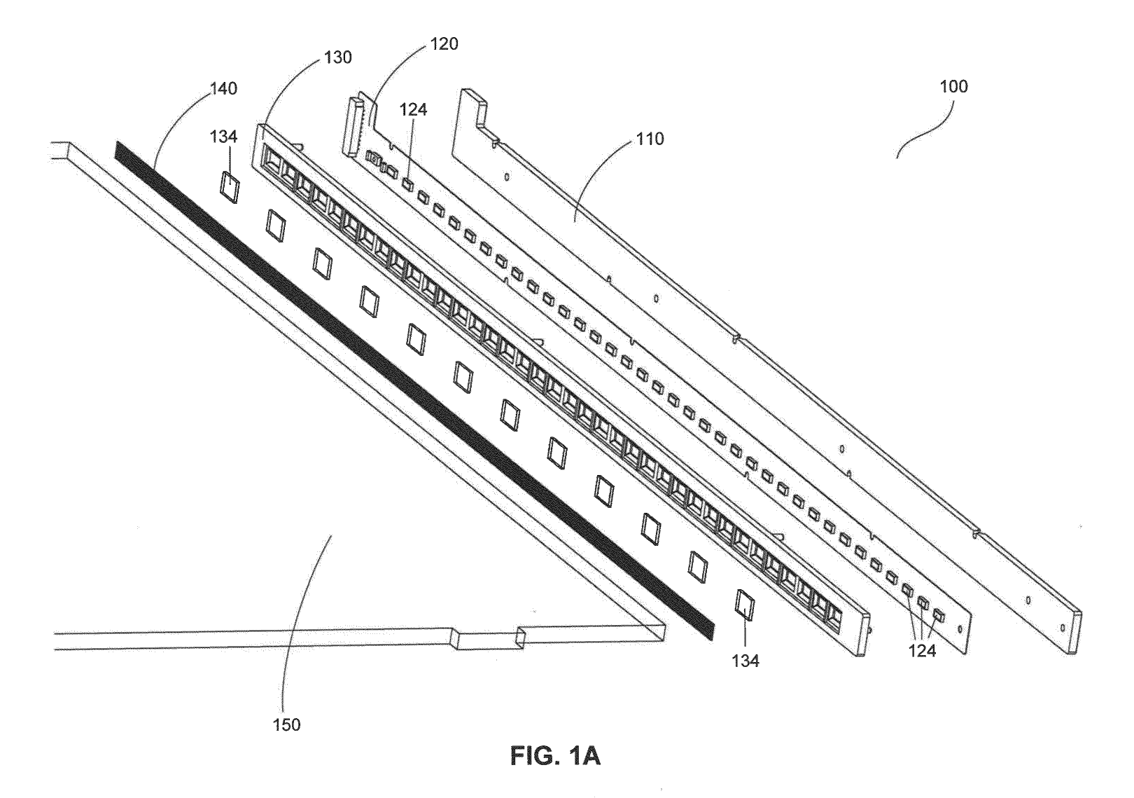

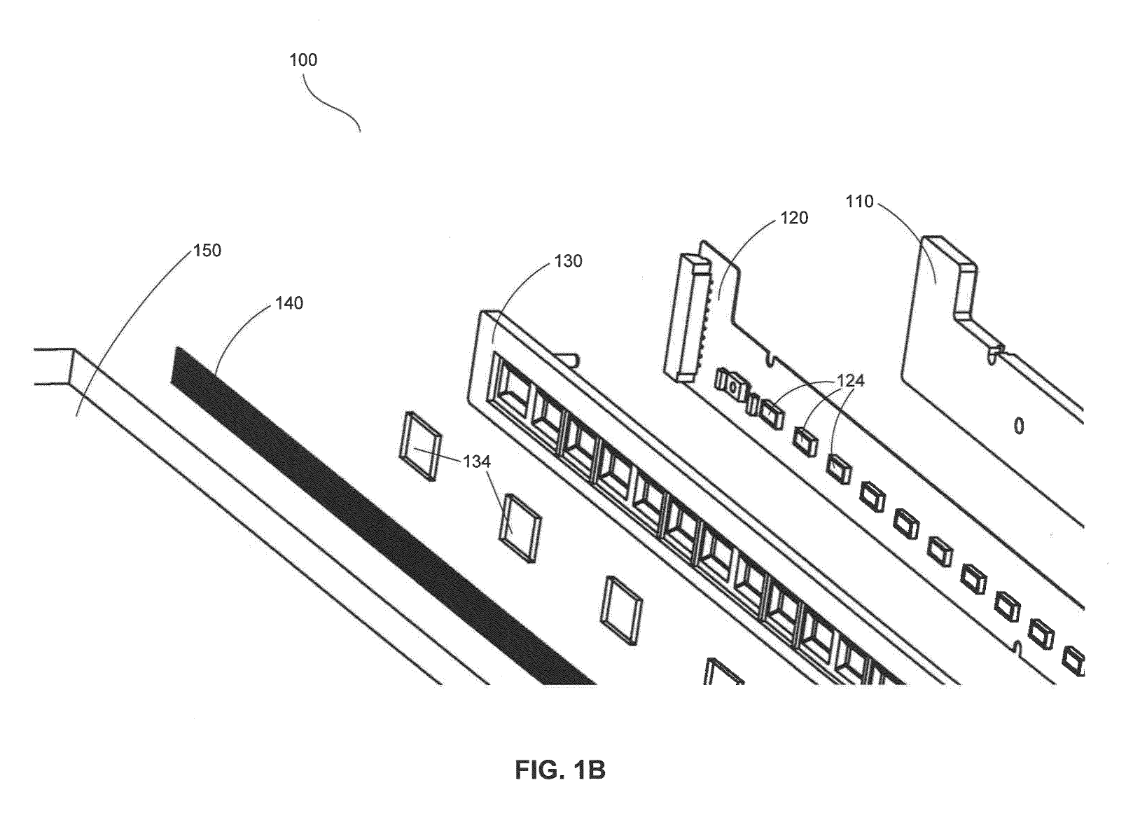

In accordance with an exemplary embodiment, and with reference to FIGS. 1A, through 2B, an exemplary dual-mode LCD backlighting system 100 generally comprises a heat sink 110, an LED printed circuit board (PCB) assembly 120, a reflector frame 130, an optical film 140, and a light guide 150.

PCB assembly 120 provides illumination via one or more LEDs 124. In various exemplary embodiments, PCB assembly 120 comprises one or more LEDs 124 coupled to a single-layer FPC. In certain exemplary embodiments, PCB 120 is configured with a light sensor, for example light sensor 122, in order to facilitate selection and/or switching of backlighting system 100 between day-mode and night-mode operation. In various exemplary embodiments, PCB 120 is configured to be thermally coupled to heat sink 110, for example via a thermally conductive adhesive, PCB assembly may also be configured with various components to allow operation of LEDs 124 and/or light sensor 122, for example electrical connector 123.

PCB assembly 120 may be configured with any suitable number of LEDs 124. LEDs 124 may be similar to one another; moreover, various LEDs 124 having differing size, shape, current requirements, luminosity, and/or emission spectrum may be utilized, In an exemplary embodiment, for a 12.1 inch LCD screen, PCB assembly 120 is configured with thirty-six (36) LEDs 124 arranged in three alternating strings of 12 LEDs each. In another exemplary embodiment, for a 14.1 inch LCD screen, PCB assembly 120 is configured with forty-eight (48) LEDs 124 arranged in four alternating strings of 12 LEDs each. In various exemplary embodiments, PCB assembly 120 is configured with from as few as 12 LEDs 124 to as many as 120 LEDs 124. Stated generally, PCB 120 may be configured with a number and type of LEDs 124 to achieve a desired luminosity, power draw, thermal behavior, or other system criterion, for example in connection with a desired LCD screen size.

In an exemplary embodiment, LED 124 comprises a NICHIA brand NFSW157A LED rated at 150 mA. In various other exemplary embodiments, fir example in connection with large LED screens, LED 124 comprises one or more high power LEDs, for example a Cree brand Xlamp ML-C LED, a Seoul Semi brand Z-Power LED, or a Phillips brand Luxeon Rebel LED. In various exemplary embodiments, PCB assembly 120 is configured with two or more types of LEDs 124 (for example, high power LEDs and low power LEDs), for example in order to preserve minimum light levels for night mode operation of backlighting system 100. In an exemplary embodiment, PCB assembly 120 is configured with a first set of LEDs 124 drawing 500 mW or more of power; these LEDs 124 are active only in day mode in order to provide higher day mode luminance. In this exemplary embodiment, PCB assembly 120 is configured with a second set of LEDs 124 drawing 250 mW or less of power; these LEDs may be filtered in order to be active in both day mode and night mode.

In an exemplary embodiment, LED 124 is configured with dimensions of about 1.5 mm wide and about 3.0 mm long. It will be appreciated, however, that LED 124 may be sized as desired, for example in order to achieve a desired luminosity. For example, large monitor backlights may be configured with 3.5 mm×3.5 min 0.5 watt LEDs, 5 mm×5 mm 1 watt LEDs, or larger LEDs. Additionally, in various exemplary embodiments, in connection with higher output backlights, lower power LEDs 124 may be used for the filtered, night more light sources to allow broader dimming range without flicker.

In various exemplary embodiments, PCB assembly 120 may be configured with one or more microprocessors, microcontrollers, and/or other suitable devices or circuitry to control and/or drive operation of LEDs 124. In certain exemplary embodiments, backlighting system 100 may be configured with a “day mode” wherein all LEDs 124 are active. Moreover, backlighting system 100 may also be configured with a “night mode” wherein only a portion of LEDs 124 are active (for example, only LEDs 124 filtered by NVIS filters 134 as discussed hereinbelow). In this manner, backlighting system 100 can “re-use” certain illumination components in multiple illumination modes. Stated another way, backlighting system 100 is configured with illumination components that are active in both daytime and nighttime illumination modes, simplifying backlighting system 100 and reducing space by eliminating certain components, such as night-mode-only illumination components.

Heat generated by operation of components on PCB assembly 120 is at least partially transferred by heat sink 110. In general, heatsink 110 is configured to transfer heat from PCB assembly 120 to a display chassis or other suitable thermal sink or radiator. In various exemplary embodiments, heat sink 110 is shaped similarly to PCB assembly 120; however, heat sink 110 may be sized and/or shaped in any suitable manner configured to facilitate suitable thermal transfer from PCB assembly 120. Heatsink 110 may comprise copper, aluminum, or other suitable thermally conductive material. In one exemplary embodiment, heatsink 110 is configured as a generally planar sheet of copper which is approximately coextensive with PCB 120 and has a thickness of between about 1 mm and about 2 mm. In another exemplary embodiment, heatsink 110 is configured as a generally planar sheet of aluminum (for example, 1100 aluminum, 6063 aluminum, or the like) which is approximately coextensive with PCB 120 and has a thickness of between about 1 mm and about 2 mm. In various exemplary embodiments, heatsink 110 may be coated with clear passivate or other suitable coating.

Heatsink 110 may be directly coupled to PCB assembly 120, for example via a thermally conductive adhesive; moreover, heatsink 110 may be integrally formed with and/or a part of PCB assembly 120, for example when PCB assembly is configured as a metal clad PCB. In various exemplary embodiments, heatsink 110 is disposed on a first side of PCB assembly 120, and components configured to guide and/or filter the light emitted by LEDs 124 are disposed on a second, opposite side of PCB assembly 120.

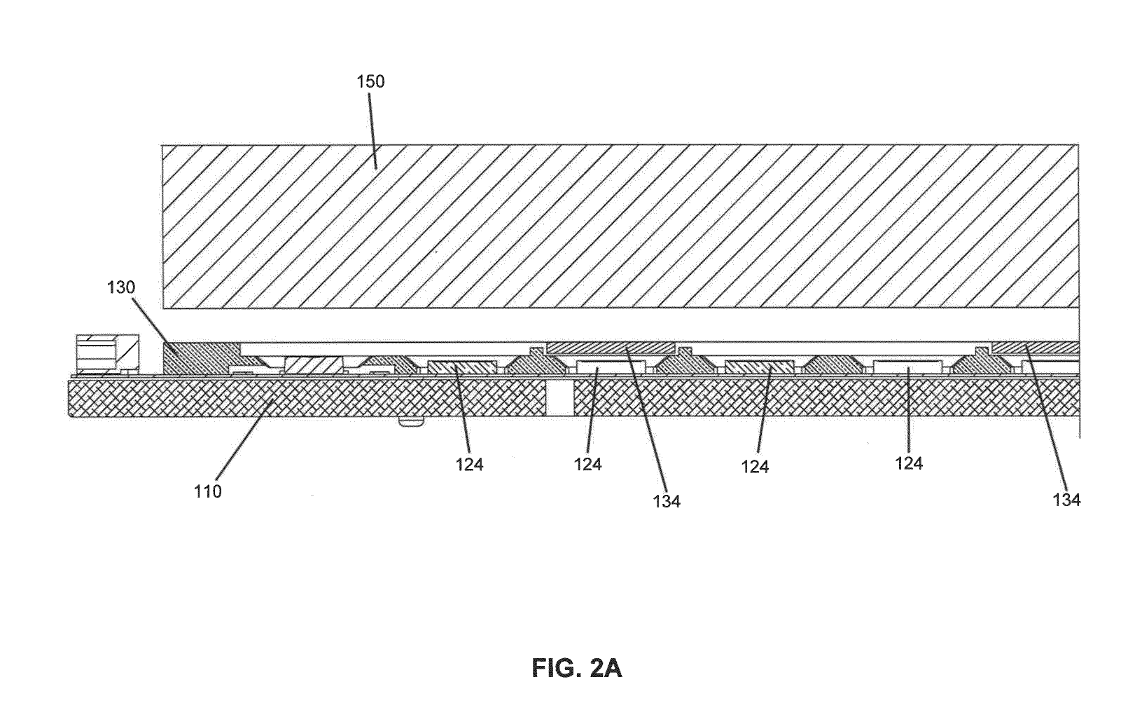

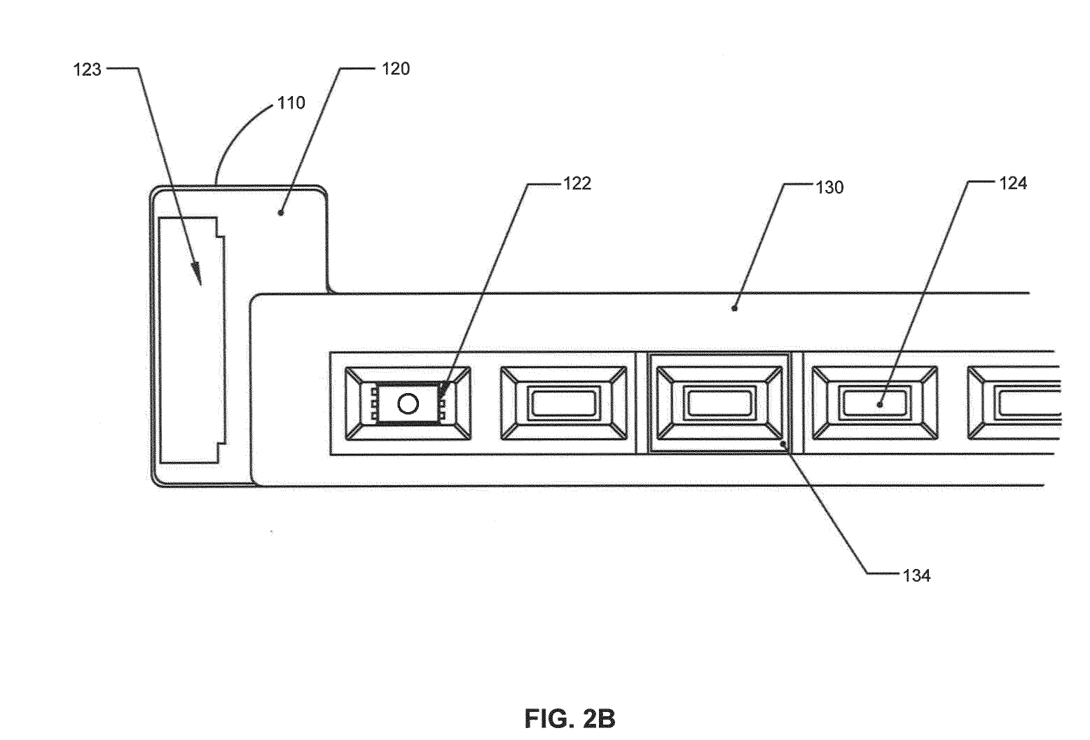

Continuing to reference FIGS. 1A through 2B, in various exemplary embodiments backlight system 100 includes a reflector frame 130 configured to reflect, direct, and/or otherwise modify light emitted from LEDs 124. Reflector frame 130 is coupled to PCB assembly 120.

In an exemplary embodiment, reflector frame 130 comprises acrylonitrile butadiene styrene (ABS) plastic. In another exemplary embodiment, reflector frame 130 comprises a blend of polycarbonate and ABS plastic. In various other exemplary embodiments, reflector frame 130 comprises one or more of polycarbonate, poly (methyl methacrylate) (PMMA), and/or the like.

In various exemplary embodiments, reflector frame 130 is configured with a plurality of wells 132. Each well 132 corresponds to one LED 124 disposed on PCB assembly 120, Each well 132 may be configured to reflect, direct, and/or otherwise shape and/or guide light emitted from an LED 124, for example via a reflective coating within each well 132. In an exemplary embodiment, wells 132 and/or other portions of reflector frame 130 may be configured with an aluminum coating deposited via vacuum metallization in order to reflect and/or direct light from LEDs 124 while preventing leakage of unfiltered light from the filtered light well.

In various exemplary embodiments, certain wells 132 in reflector frame 130 may be coupled to and, or capped by one or more filters, for example NVIS filters 134. For example, wells 132 corresponding to LEDs 124 which will remain active during night mode operation of backlighting system 100 may be capped with NVIS filters 134. In an exemplary embodiment, a NVIS filter 134 may be placed filter side down into a well 132 and secured with a suitable adhesive, for example black silicone RTV. In this manner, radiation leakage around the edge of NVIS filter 134 may be reduced and/or eliminated.

NVIS filter 134 may comprise any suitable filter or filters configured to filter out a desired portion of the electromagnetic spectrum. NVIS filter 134 may be constructed from any suitable material. In various exemplary embodiments, NVIS filter 134 comprises soda-lime glass, borosilicate glass, aluminosilicate glass, and/or the like. NVIS filter 134 may be configured with any suitable thickness, for example a thickness between about 0.3 mm and about 2 mm. In one exemplary embodiment, NVIS filter 134 is configured with a thickness of about 0.5 mm.

In an exemplary embodiment, NVIS filter 134 is configured with a dichroic coating having a filter cut-off of between about 600 nm and about 620 nm. In another exemplary embodiment, NVIS filter is configured as a short-pass filter having a filter cut-off of between about 650 nanometers and about 680 nanometers. In typical exemplary embodiments, NVIS filter 134 is configured with an average transmission of over 90% for light having wavelengths of between about 450 nm and about 625 nm and an average transmission of less than about 0.1% for light having wavelengths of between about 725 nm and about 950 nm. In these exemplary embodiments, the 50% transmission point is located within about plus/minus 7 nm around 650 nm. Moreover, NVIS filter 134 may be configured with any suitable coatings, materials, and or the like, in order to achieve a desired filter performance. In certain exemplary embodiments, while referred to herein as NVIS filter 134, filters 134 configured in accordance with principles of the present disclosure may be configured as narrow band-pass filters for selectively transmitting narrow spectra of red, green, blue or other spectral region of light, including multi-band pass filters. In various exemplary embodiments, NVIS filter 134 is configured to reduce and/or eliminate transmission of infrared radiation to a backlight for an LCD display.

NVIS filters 134 may be placed over a desired number of LEDs 124 in backlighting system 100, for example in order to achieve a desired level of night-mode illumination. In an exemplary embodiment, an NVIS filter 134 is placed over every other LED 124 in backlighting system 100. In another exemplary embodiment, for example with reference to FIG. 1B, an NVIS filter 134 is placed over every third LED 124 in backlighting system 100. In yet another exemplary embodiment, an NVIS filter 134 is placed over every fourth LED 124 in backlighting system 100. LEDs 124 filtered by NVIS filters 134 may be interleaved, staggered, interspersed, or otherwise utilized in connection with non-filtered LEDs 124 in order to provide a suitable level of illumination for one or more modes of operation of backlighting system 100.

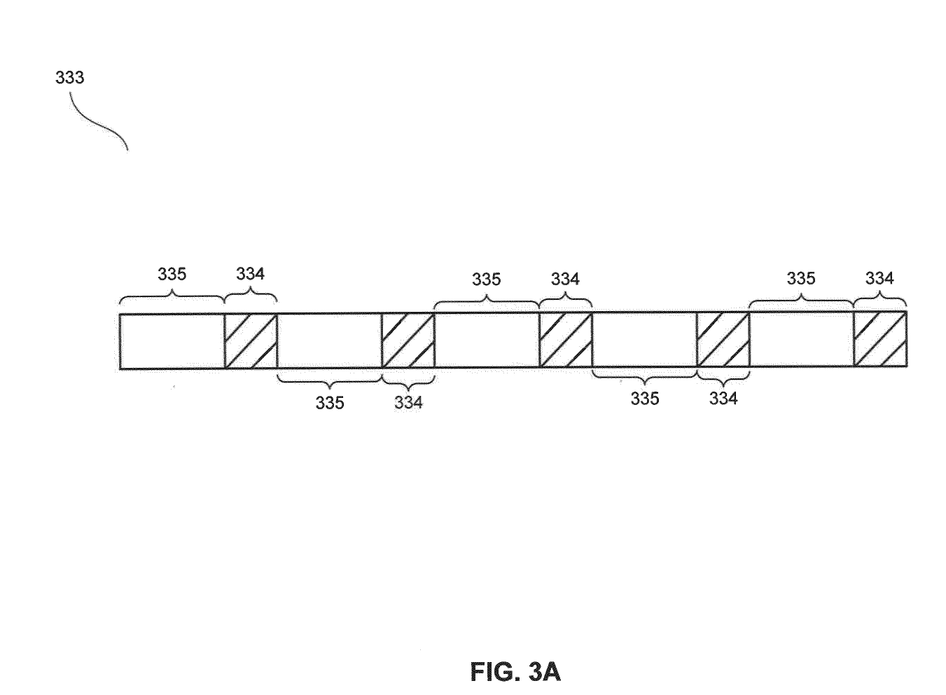

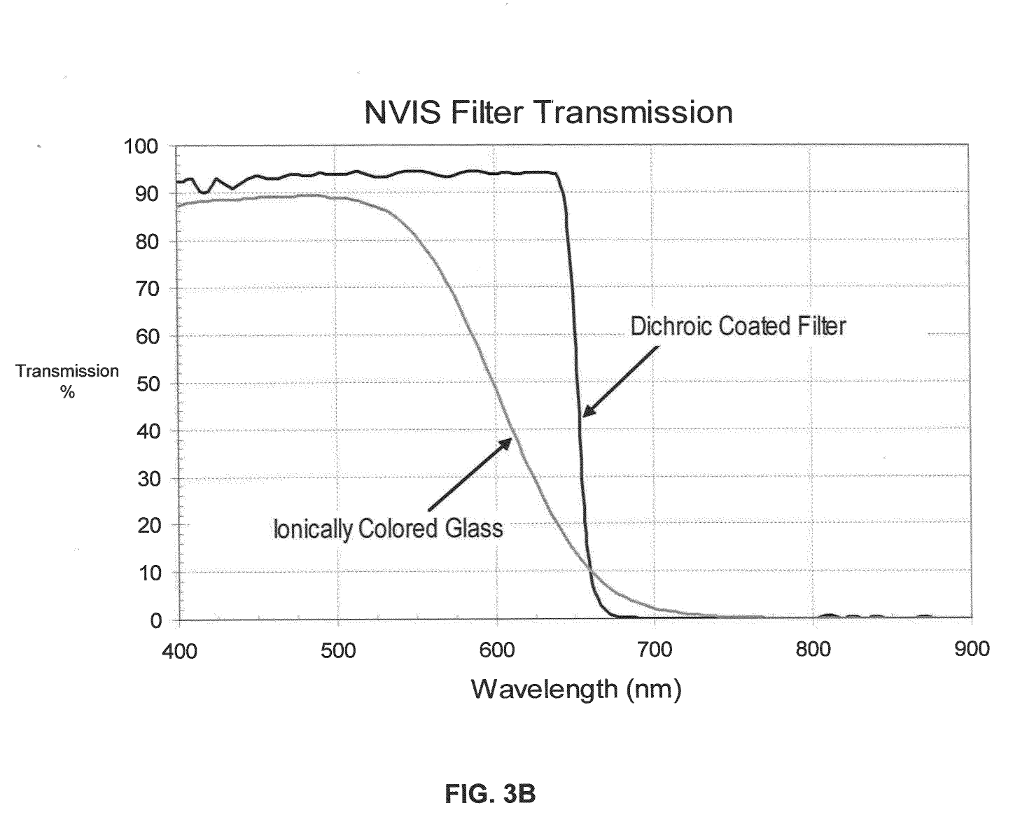

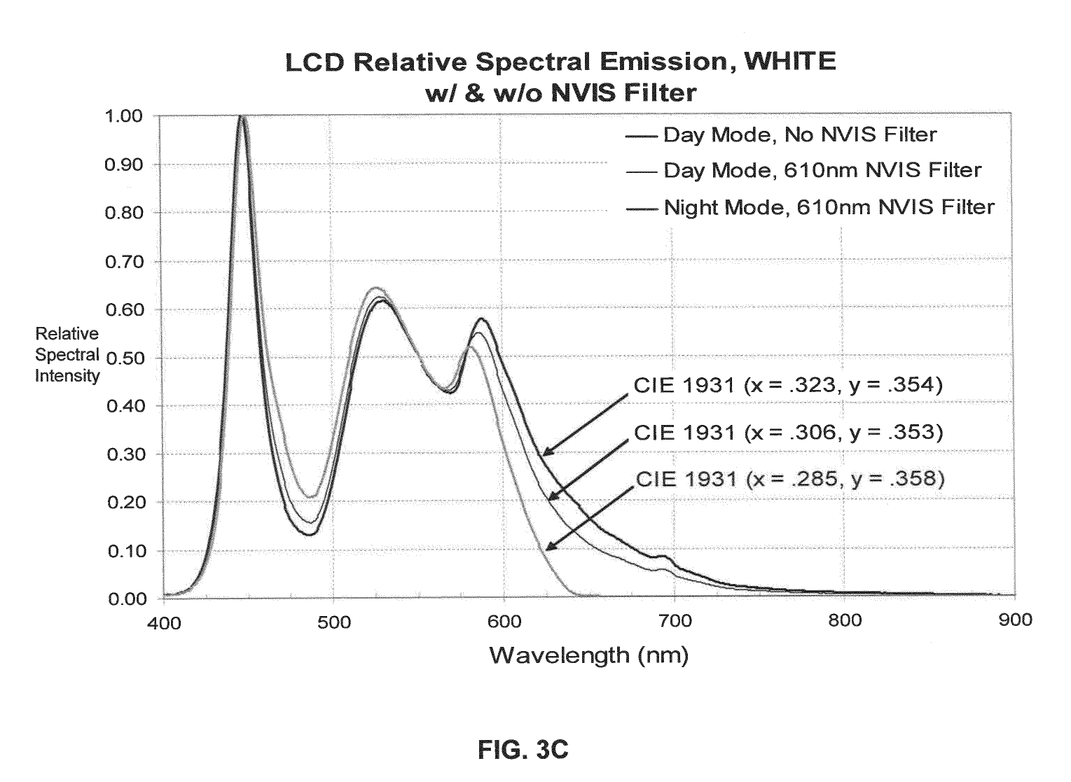

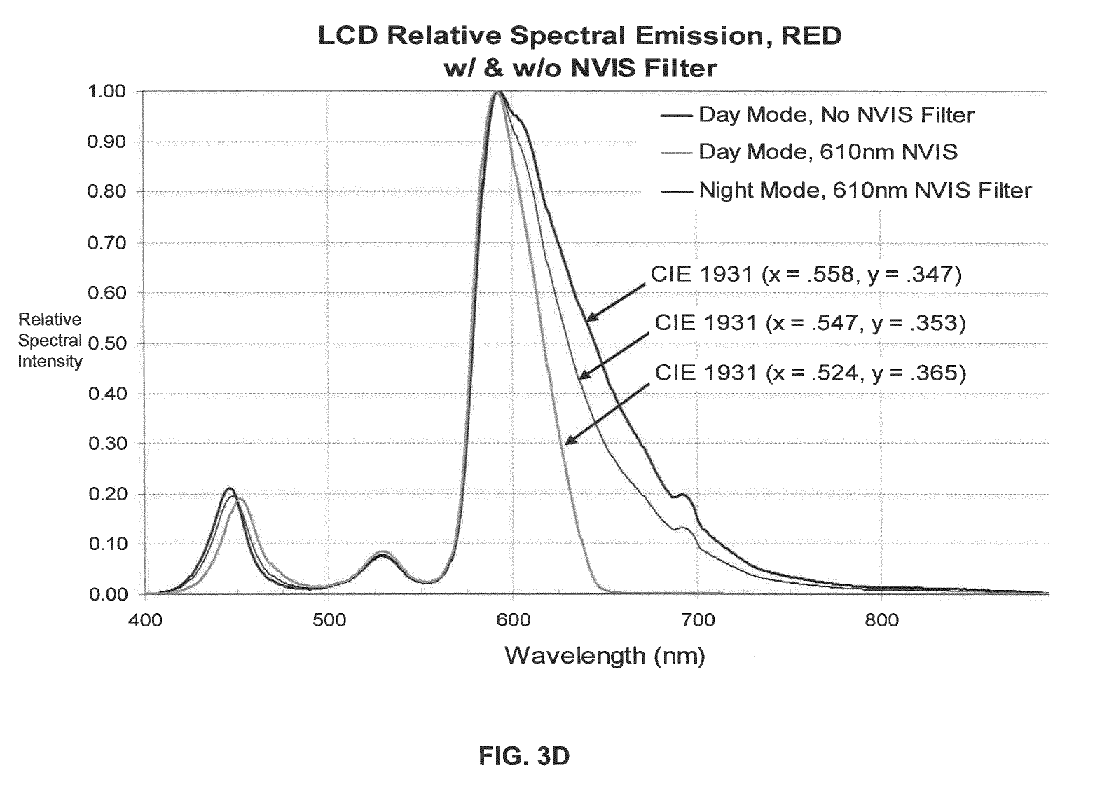

With momentary reference to FIG. 3B, in various exemplary embodiments NVIS filter 134 is configured with a steep filter curve that minimizes color shift. FIG. 3B illustrates a spectral transmission curve for one configuration of an exemplary filter 134; the dichroic coated filter. The dichroic coated filter depicted has a 50% transmission at roughly 652 nm. More importantly, it has a 90% transmission 643 nm. and a 5% transmission at roughly 663 nm. Thus, in only 20 nm bandwidth, the dichroic coated filter drops from full transmission to less than 5% transmission. By contrast, as also illustrated in FIG. 3B, an ionically colored glass filter has a much less steep cut-off, with a 85% to 5% bandwidth of roughly 143 nm and at 700 nm still has a transmission of 2%, while the dichroic filter has less than 0.05% transmission at 700 nm. The result of the ionically colored glass filter characteristic is a much greater reduction in Red spectral energy due to the absorption at below 60 nm in order to achieve the desired IR blocking above 700 nm.

In various exemplary embodiments, NVIS filter 134 may be configured with a filter curve selected at least in part based on LED red-green spectral distribution. In these exemplary embodiments, a LED 124 that is filtered by NVIS filter 134 remains suitable for use in day-mode illumination due to the minimal color shift.

For example, turning now to FIGS. 3C and 3D, benefits and advantages of various exemplary embodiments can be seen. Specifically, FIGS. 3C and 3D illustrate White and Red color performance of a stock LCD module (No NVIS filter) as well as the same LCD module fitted with LCD backlighting system 100 in both Day Mode (unfiltered and filtered LEDs turned ON simultaneously) and Night Mode (only the filtered LEDs turned ON). Since, in this exemplary embodiment illustrated, two-thirds of the LEDs are unfiltered, and since the filtered LEDs use dichroic filter technology, the Day Mode chromaticity of the White field sees only a minimal shift in CIE chromaticity of only about Δxy=0.017 from the stock panel. Even the Night Mode chromaticity is still within the acceptable range for night operations with a Δxy=0.021 difference from the Day Mode display. Likewise, for Red fields the Day Mode chromaticity sees only a shift in chromaticity of only Δxy=0.012 from the stock panel while the Night Mode chromaticity is still within the acceptable range for night operations with a Δxy=0.026 difference from the Day Mode display. While not illustrated in FIGS. 3C and 3D, it is readily apparent why either a monolithic filter or an ionically colored filter would result in much larger color shifts and potentially unacceptable Day Mode performance due to the larger reduction in Red energy in the 585 nm to 650 nm range.

Optical film 140 is configured to disperse light, for example in order to provide an increased level of light uniformity in close proximity to the light rail assembly. In an exemplary embodiment, optical film 140 is configured with a diffractive optics structure having a high aspect elliptical output profile (e.g. 1°×100° minor/major). In various exemplary embodiments, optical film 140 is configured with a diffractive optics structure having an output profile selected at least in part based on the spacing of LEDs 124 in backlighting system 100. In various exemplary embodiments, optical film 140 is configured with a diffractive optics structure having an elliptical output profile from about 1°×100° minor/major to about 5′×60° minor/major. In various exemplary embodiments, optical film 140 is disposed between reflector frame 130 and light guide 150 (for example, adhered to the inlet to light guide 150). Optical film 140 may be configured with any suitable dimensions sufficient to achieve a desired level of light uniformity near the light rail assembly. In an exemplary embodiment, optical film 140 is configured with dimensions of about 3 mm tall by about 0.125 mm thick. Semi-custom diffractive optical elements suitable for forming optical film 140 are available from manufacturers such as Luminit Co. of Torrance, Calif., Wavefront Technology, Inc. of Paramount, Calif., and Reflexite Energy Solutions of Avon, Conn.

With continued reference to FIGS. 1A and 1B, light guide 150 is configured to transmit and disperse light across an LCD display. In an exemplary embodiment, light guide 150 comprises one or More of PMMA, cyclic olefin polymer (COP), or polycarbonate. Light guide 150 may be configured with any suitable thickness in the direction perpendicular to the plane of the display, For example, light guide 150 may be configured with a thickness of between about 2 mm and about 5 mm. In an exemplary embodiment, light guide 150 is configured with a thickness of about 3 mm. Optical film 140 may be coupled to the inlet size of light guide 150 in order to more evenly disperse light therein.

It will be appreciated that the foregoing exemplary components of backlighting system 100 are recited by way of illustration and not of limitation, and that a backlighting system configured in accordance with principles of the present disclosure may be configured with fewer components and/or additional components, as suitable. For example, in various exemplary embodiments, optical film 140 may be omitted when light guide 150 is configured with a suitable diffractive optics structure on the light guide inlet edge. For example, a suitable diffractive optics structure may be formed on the light guide inlet edge by molding or embossing using well-known micro-replication processes.

For example, in an exemplary embodiment, surface mount LEDs 124 are attached to a single flexible PCB assembly 120 which utilizes single-layer circuit routing in three interleaved parallel strings of series LEDs on a 6.5 mm pitch. In this exemplary embodiment, a 12.1″ diagonal display design was implemented using 36 LEDs (3 parallel×12 series) with a package outline of 1.5×3.0 mm×0.8 mm thick. The PCB assembly is attached to a 1.5 mm thick aluminum heat sink 110 using thermally conductive film adhesive.

In this exemplary embodiment, an injection molded plastic reflector with vacuum metalization over-coating is mounted over PCB assembly 120 and is secured to heat sink 110 by heat staking of several protrusions formed in the frame. The molded reflector 130 includes a plurality of tapered wells 132 around each of the LEDs 124 to project light forward. The vacuum metalization acts to increase the reflective efficiency while preventing IR light leakage around the filters, IR filters 134 with a suitable wavelength cutoff (for example, from about 600 nm to about 650 nm) are placed in roughly 3×5 min×0.5 mm deep wells 132 which are formed on the light guide facing side of reflector frame 130. A thin bead of black adhesive retains the filters 134 in reflector frame 130 while preventing light leaks around the filter edges.

In this exemplary embodiment, the total thickness of the LED rail assembly including heat sink 110, PCB assembly 120, LEDs 124, reflector frame 130 and IR filters 134 is only 3.25 mm, Including the small air gap to optical film 140, total thickness from the rear surface of heat sink 110 to the inlet face of light guide 150 is less than 5 mm.

Light guide 150 thickness in the direction perpendicular to the plane of the display is 3 mm.

In various exemplary embodiments, the total thickness of the LED rail assembly is between about 2 mm and about 5 mm. In these exemplary embodiments, total thickness from the rear surface of heat sink 110 to the inlet face of light guide 150 is less than 6 mm, and is often less than 3 mm. In these exemplary embodiments, light guide 150 thickness in the direction perpendicular to the plane of the display is between about 2 mm and about 6 mm.

In an exemplary embodiment, backlight system 100 was integrated in and tested in a 12.1″ color thin film transistor (TFT) module with an EMI filtered, circular polarized, resistive touch panel (˜65% transmission) bonded to the LCD front surface. Backlight system 100 was configured with 36 100 mA LEDs 124, with 12 night-mode LEDs filtered by 650 nm cutoff NVIS filters 134. With the backlight power in day-mode at 10.8 watts, the display white luminance was over 730 cd/m² (˜1100 cd/m² on the bare LCD). NVIS mode performance was evaluated using an Optronics Laboratories OL730C radiometer. With only the night-mode LEDs 124 operating at ˜2.5 mA RMS for a white luminance of 1.9 cd/m², the NVIS B radiance of the display module was 1.01 nNR_{B} against a maximum of 2.30 nNR_{B} as defined by MIL-STD-3009, Table III. In this exemplary embodiment, backlight system 100 exceeds the performance required for NVIS B compatible displays as defined by MIL-STD-3009.

Turning now to FIG. 3A, in various exemplary embodiments, backlighting system 100 may be configured, not with individual NVIS filters (for example, as illustrated in FIGS. IA through 2B and discussed hereinabove), but rather with a monolithic filter 333. Monolithic filter may comprise any suitable materials. In various exemplary embodiments, monolithic filter 333 comprises one or more of borosilicate glass, aluminosilicate glass, and/or the like.

In an exemplary embodiment, monolithic filter 333 is configured with patterned multi-layer coating(s), for example placing NVIS filter coated areas 334 only in certain desired locations associated with night-mode LEDs, leaving adjacent areas 335 without IR filtering. This approach can greatly simplify the assembly of filters to the reflector frame and reducing assembly part count. Moreover, in this exemplary embodiment, modifications to molded reflector 130 may be implemented in order to eliminate portions which previously separated NVIS filters 134.

As discussed hereinabove, in various exemplary embodiments one or more LEDs 124 may be placed on a single layer flexible printed circuit board 120. FPC 120 may be bonded to an aluminum heat sink 110 as an assembly step.

In various other exemplary embodiments, FTC 120 and heat sink 110 may be replaced with a single layer metal dad printed circuit board 129 as is common in high power LED applications. Such approaches can potentially offer improved thermal performance. In still other exemplary embodiments, in order to achieve improved thermal performance, LEDs 124 are operated below their rated current; in order to achieve a similar level of luminosity, in these exemplary embodiments the number of LEDs 124 may generally be increased in comparison to embodiments wherein LEDs 124 are operated at or close to their rated current.

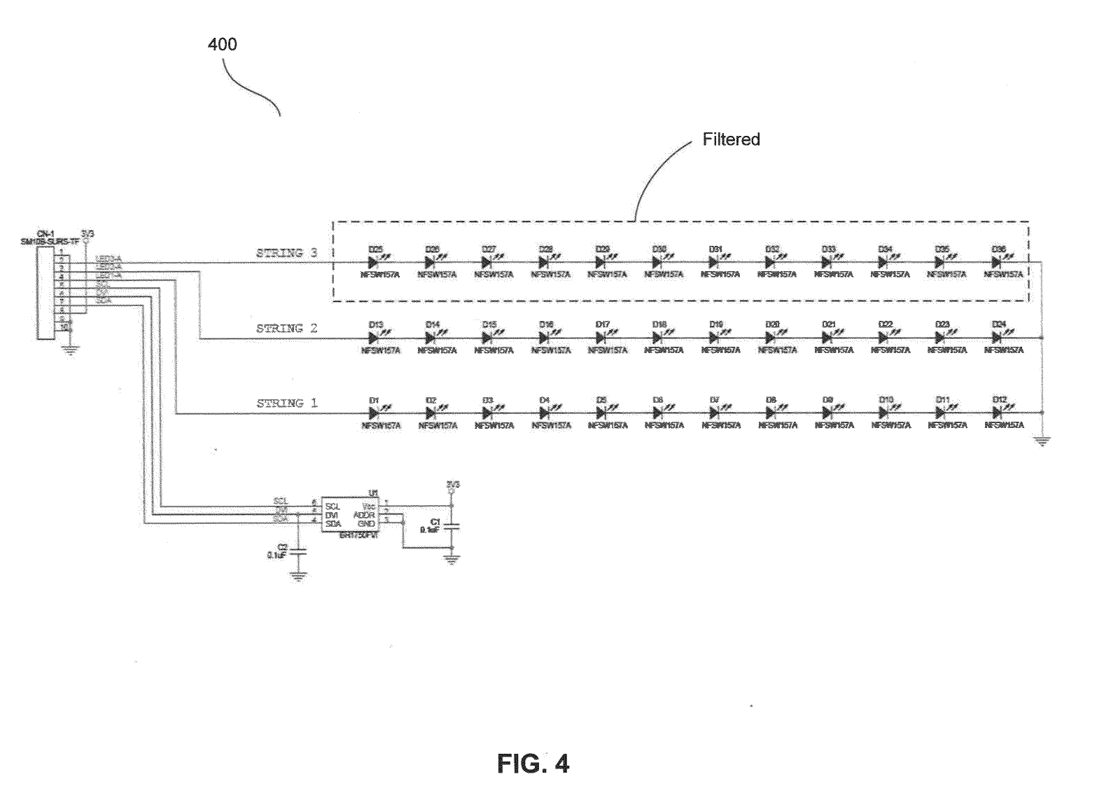

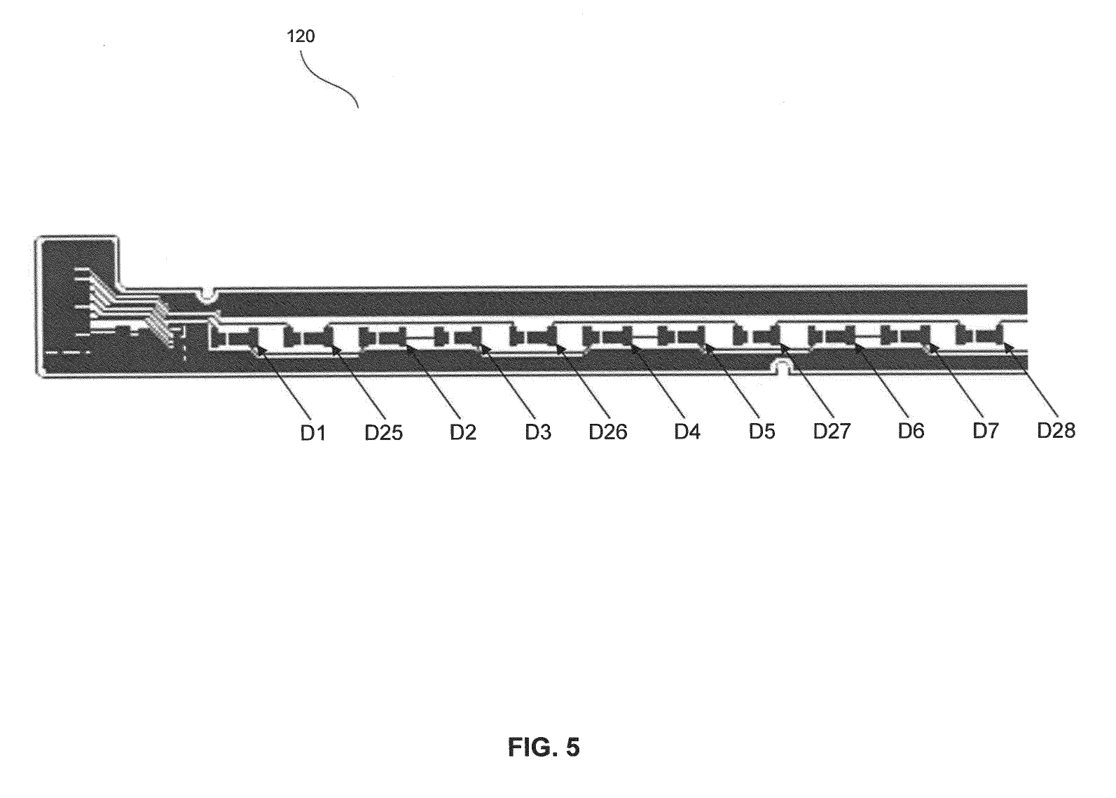

Turning now to FIGS. 2B, 4 and 5, in various exemplary embodiments LEDs 124 are laid out on a single-layer planar substrate in various combinations of parallel strings of series LEDs. in an exemplary embodiment, backlighting system 100 may be configured with thirty-six LEDs 124, for example as illustrated in FIG. 4 wherein LEDs 124 are designated with labels D1 through D36. Additional components depicted include interface connector 123, light sensor 122, and a pair of capacitors (labeled C1 and C2 in FIG. 4) that are part of the light sensor circuit. The strings of LEDs 124 may be controlled by a current controlled driver (not shown) with the anodes tied in common return to reduce connector pin count. Dimming and day/night mode operation may be controlled by the LED driver circuit.

With reference now to FIG, 5, in various exemplary embodiments PCB assembly 120 may be configured with an exemplary trace routing as partially illustrated. For example, PCB assembly 120 may be configured with a. single-layer, 3 parallel by 12 series arrangement of LEDs 124, wherein one-third of the LEDs 124 are filtered as discussed hereinabove.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A mode-selectable backlighting system, comprising:
a plurality of discrete light sources, wherein the plurality of discrete light sources comprises a first group of discrete light sources and a second group of discrete light sources;
a reflector having reflector cavities, each cavity corresponding to one of the plurality of discrete light sources; and
a plurality of filters coupled to the reflector, wherein one of the plurality of filters is disposed over each reflector cavity corresponding to one of the second group of discrete light sources.

2. The system of claim 1, further comprising a controller coupled to the first group of light sources and the second group of light sources, wherein the first group of light sources and the second group of light sources are independently controllable.

3. The system of claim 1, wherein the reflector cavities optically separate the discrete light sources.

4. The system of claim 1, wherein the filters are dichroic filters.

5. The system of claim 1, wherein the filters are short-pass filters with a wavelength cut-off of between about 620 nanometers and about 650 nanometers.

6. The system of claim 1, wherein the filters are short-pass filters with a wavelength cut-off of between about 650 nanometers and about 680 nanometers.

7. The system of claim 1, wherein the filters are narrow band-pass filters for selectively transmitting narrow spectra of red, green, blue or other spectral region of light including multi-hand pass filters.

8. The system of claim 1, further comprising a light guiding plate having at least one inlet face located on at least one edge and one outlet face.

9. The system of claim 8, wherein the inlet face is configured with an optical structure for spreading the incident light disposed thereon,

10. The system of claim 9, wherein the optical structure is a series of diffractive optical elements formed directly on the inlet face.

11. The system of claim 9, wherein the optical structure is a series of diffractive optical elements formed on film and attached to the inlet face of the light guiding plate.

12. The system of claim 8, wherein the plurality of discrete light sources are disposed along only one side of the light guiding plate.

13. The system of claim 1, wherein the first group of light sources are interleaved with the second group of light sources.

14. The system of claim 1, wherein the first group of light sources contains double the number of light sources as the second group of light sources.

15. The system of claim 1, further comprising a light sensor, wherein the first group of light sources is powered off responsive to the light sensor reporting ambient illumination below a threshold value.

16. The system of claim 1, wherein the first group of light sources and the second group of light sources are both powered on responsive to the light sensor reporting ambient illumination above a threshold value.

17. The system of claim 1, further comprising;
a printed circuit board, wherein the plurality of discrete light sources are coupled to the printed circuit board; and
a heat sink coupled to the printed circuit board

18. The system of claim 17, wherein the printed circuit board is at least one of a flexible printed circuit board or a metal clad printed circuit board.

19. The system of claim 1, wherein the plurality of filters comprise coatings on a single, monolithic substrate.

20. A single-edge LCD backlighting system, comprising:
a printed circuit board having a. plurality of discrete light sources mounted on a single side thereof, the plurality of light sources comprising a first set of light sources and a second set of light sources;
a reflector having reflector cavities, each cavity corresponding to one of the plurality of discrete light sources; and
a plurality of dichroic coated infrared cut-off filters coupled to the reflector, wherein one of the plurality of filters is disposed over each reflector cavity corresponding to one of the second group of discrete light sources.

21. The system of claim 20, wherein the first set of discrete light sources and the second set of discrete light sources are active in day mode operation, and wherein the second set of discrete light sources are active in night mode operation.

22. A method of forming a dual-mode LCD backlighting system, the method comprising:
providing a first set of discrete light sources and a second set of discrete light sources, the first set and the second set interleaved on a single side of a printed circuit board;
coupling the printed circuit board to a reflector having reflector cavities;
coupling an infrared filter to each reflector cavity corresponding to one of the second set of discrete light sources; and
coupling the reflector to single side of a light guide plate.

23. The method of claim 22, wherein the light guide plate is coupled to a diffractive film on the inlet side of the light guide plate.

24. The method of claim 22, wherein the first set of discrete light sources and the second set of discrete light sources are active in day mode operation, and wherein the second set of discrete light sources are active in night mode operation.
